(19) United States
(12) Patent Application Publication
(10) Pub. No.: US 2007/0132799 A1
(43) Pub. Date: Jun. 14, 2007

(54) Image recording apparatus

(75) Inventor: Takayuki Ilda, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Coporation, Tokyo (JP)

(21) Appl. No.: 11/634,278

(22) Filed: Dec. 6, 2006

(30) Foreign Application Priority Data
Dec. 8, 2005 (JP) 2005-354870

(51) Int. Cl. B41J 29/38

(52) U.S. Cl. 347/16

(57) ABSTRACT

The image recording apparatus forms respective images on two or more types of printing media having different widths. The apparatus includes an ink ejection device for ejecting ink droplets toward a surface of a printing medium in the two or more types of printing media and a pair of ink receivers which are positioned near to both side edges of the printing medium in a width direction perpendicular to a transport direction of the printing medium and receive the ink droplets ejected from the ink ejection device and landed beyond the both side edges of the printing medium in the width direction. At least one ink receiver of the pair of ink receivers is moved in the width direction in accordance with widths of the two or more types of printing media having the different widths.

### BACKGROUND OF THE INVENTION

This invention relates to an image recording apparatus for producing borderless prints by using an ink jet print head, and more particularly to an image recording apparatus for performing borderless printing on printing media of different widths.

Ink jet printers that eject ink droplets from an ink jet print head on a recording medium such as a recording sheet and form an image thereon have been widespread. Images printed by the ink jet printers have an image quality almost equal to that of silver halide photographs because of the recent progress of the image processing technology, image recording technology, and ink jet print head designing.

In the photographic prints produced by digital photo printers, a print with no blank spaces or the like around an image, i.e., a borderless print bearing an image recorded up to the borders (edges) thereof has been mainstream, and ink jet printers that can print images with no blank spaces around them are in practical use. In the case of borderless printing by an ink jet printer, ink needs to be ejected even beyond the edges of a recording medium to form an image on the recording medium, so that an ink receiver or the like is provided by the side of the recording medium to protect the inside of the printer from being contaminated due to the ink ejected outside the recording medium.

For example, there is disclosed an ink jet printer in JP 2003-104600 A. In order to protect a printing medium from being blotted with the ink ejected outside the printing medium, the ink jet printer uses a transport belt which has a width narrower than that of the printing medium as the belt for transporting the printing medium under attraction by suction, and includes an ink receiver for receiving the ink ejected outside the printing medium.

JP 2004-082385 A describes an ink jet printer having an ink receiving unit which is provided with an absorptive material for absorbing the ink ejected outside the printing area of printing paper, and is moved so as to prevent the ink from accumulating and thereby coming into contact with the paper to cause the staining thereof.

### SUMMARY OF THE INVENTION

In the ink jet printer disclosed in JP 2003-104600 A, two kinds of ink receivers are formed in a printing stage or table on which a printing medium is placed. One of the ink receivers is used in the case of transporting a printing medium having a narrow width, and the other is for a printing medium having a width broader than the former one. However, when an image is recorded on the printing medium having a narrow width with this ink jet printer, ink may spatter outside the relevant ink receiver to adhere there to the printing stage, or even to the transport belt and the like. Therefore, there has been a problem in that when the printing medium having a broader width is transported on the printing stage to form an image thereon, the ink having spattered to adhere to the printing stage and so forth in the transport path may cause the blotting of the back surface of the printing medium.

Ink will also adhere to the printing stage if a printing medium is displaced in the width direction when transported, with its edges being off the relevant ink receiver.

In addition, borderless printing can be performed exclusively on the printing media having predetermined widths because the ink receivers are formed in the printing stage in accordance with the widths of the printing media to be used.

The present invention has been accomplished so as to solve the above problems, and an object of the present invention is to provide an image recording apparatus that prevents ink from adhering to the transport path to cause the blotting of the back surface of a recording medium moving on a printing stage during the borderless printing on recording media of different widths.

Another object of the present invention is to provide an image recording apparatus capable of performing borderless printing also on printing media having widths other than predetermined ones.

According to the present invention, the above problems are solved by providing an image recording apparatus for forming an image on each printing medium of two or more types of printing media having different widths, including: an ink ejection device for ejecting ink droplets toward a surface of a printing medium in the two or more types of printing media; and a pair of ink receivers which are positioned near to both side edges of the printing medium in a width direction perpendicular to a transport direction of the printing medium, and receive the ink droplets ejected from the ink ejection device and landed beyond both the side edges of the printing medium in the width direction, wherein at least one ink receiver of the pair of ink receivers is moved in the width direction in accordance with each of widths of the two or more types of printing media having the different widths.

It is preferable that each printing medium of the two or more types of printing media having the different widths is transported in such a way that a center of each printing medium in the width direction is positioned as a reference, and the pair of ink receivers are moved to or away from each other in a symmetric manner with respect to the center in the width direction. Alternatively, it is preferable that each printing medium of the two or more types of printing media having the different widths is transported in such a way that one side edge of each printing medium is positioned as a reference, and one ink receiver of the pair of ink receivers which is to be positioned near to another side edge of each printing medium opposite to said one side edge of each printing medium is moved in the width direction perpendicular to the transport direction of the printing medium. It is also preferable in some cases that the pair of ink receivers are moved in the width direction perpendicular to the transport direction independently of each other.

Preferably, the image recording apparatus further includes a transport guide which is moved together with the ink receiver to support the printing medium at its back and is provided on each inner side of the pair of ink receivers in the width direction perpendicular to the transport direction.

The ink ejection device is preferably reciprocated in a direction which is parallel to the surface of the printing medium and perpendicular to the transport direction of the printing medium so as to form the image on the printing medium.

According to the image recording apparatus of the present invention, either or both of a pair of ink receivers to be positioned in the vicinity of the side edges of a printing medium, respectively, are moved corresponding to the position of the side edges of the printing medium, so that adhesion of ink to the transport path for the printing medium is so avoided as to allow printed materials with no ink blots even if borderless printing is performed on printing media of multiple sizes, and, moreover, it is possible to perform borderless printing even on printing media having widths other than predetermined ones.

### BRIEF DESCRIPTION OF THE DRAWINGS

In the accompanying drawings:

FIG. 1 is a schematic illustration of the configuration of a digital photo printer according to the present invention;

FIG. 2 is a schematic plan view of an image recording section of the digital photo printer according to the present invention;

FIG. 3 is a cross-sectional view of the image recording section as shown in FIG. 2, taken along the line III-III;

FIG. 4 is a schematic plan view of a transport mechanism during the borderless printing on a recording sheet having a broad width;

FIG. 5 is a schematic plan view of an image recording section provided with a pair of ink receivers which are movable independently of each other;

FIG. 6 is a schematic cross-sectional view of an image recording section including a line print head, along with a block diagram illustrating part of a driving system of the image recording section;

FIG. 7 is a schematic cross-sectional view of an image recording section including transport guides which attract a recording sheet by suction;

FIG. 8 is a schematic cross-sectional view of an image recording section including transport guides and a printing stage each of which attracts a recording sheet by suction; and

FIGS. 9A and 9B are schematic plan views of an image recording section including a printing stage in plate form, transport guides in plate form, and movable ink receivers, with FIG. 9A showing the section during the borderless printing on a recording sheet of the narrowest width and FIG. 9B showing that during the borderless printing on a recording sheet of a broader width.

### DETAILED DESCRIPTION OF THE PREFERRED EMBODIMENTS

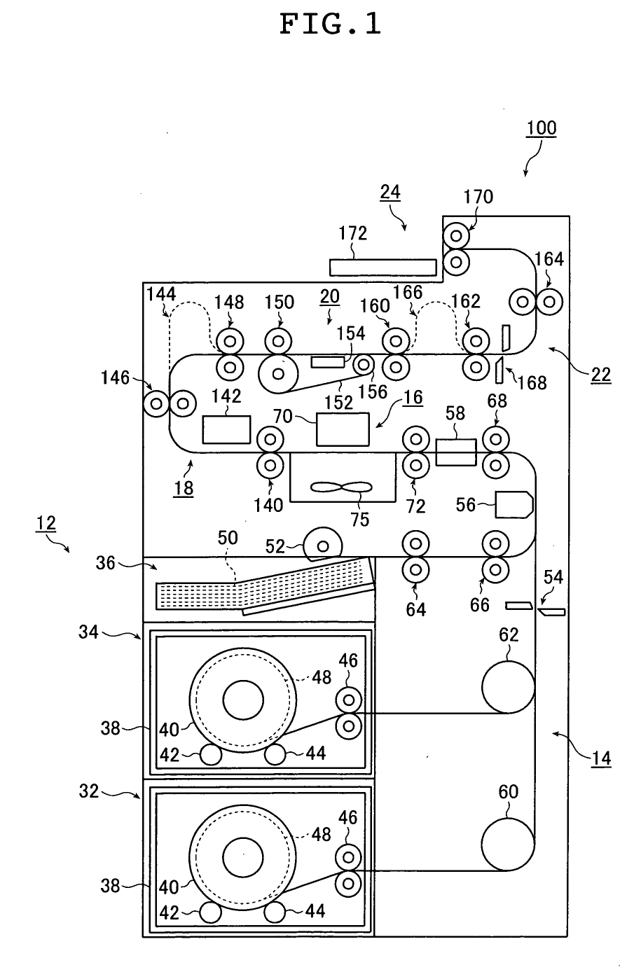

A digital photo printer according to the present invention will be described below referring to FIG. 1. FIG. 1 is a schematic illustration of the configuration of the digital photo printer.

A digital photo printer 100 comprises a recording sheet loading section 12, a recording sheet supplying section 14, an image recording section 16, a drying section 18, a surface treatment section 20, a cutting section 22, and a discharge section 24.

The recording sheet loading section 12 mainly comprises a first rolled (roll-type) recording sheet loading unit 32, a second rolled recording sheet loading unit 34, and a recording sheet cassette 36.

The first rolled recording sheet loading unit 32 is arranged at the lower part in the digital photo printer 100. The second rolled recording sheet loading unit 34 is arranged above the first rolled recording sheet loading unit 32, above which the recording sheet cassette 36 is arranged. The first rolled recording sheet loading unit 32 and the second rolled recording sheet loading unit 34 are different from each other in location but basically the same in configuration, so that the configuration of only the first rolled recording sheet loading unit 32 is explained below and the explanation of the second rolled recording sheet loading unit 34 is omitted. In FIG. 1, to each component of the second rolled recording sheet loading unit 34 that is identical to the corresponding component of the first rolled recording sheet loading unit 32, the same reference numeral is given.

As show in FIG. 1, the first rolled recording sheet loading unit 32 is arranged at the lower part in the casing of the digital photo printer 100, and comprises a magazine 38, flanges 40, flange rotation rollers 42 and 44, and a feed roller pair 46. The flanges 40, the flange rotation rollers 42 and 44, and the feed roller pair 46 are provided in the magazine 38. In the digital photo printer 100 in the illustrated example, the magazine 38 is drawn out of the printer casing, and a rolled (roll-type) recording sheet 48 as a printing medium is loaded into the magazine 38. In the case of using a rolled recording sheet having a narrow width, a plurality of rolled recording sheets may be arranged in parallel in the direction perpendicular to the plane of the figure (i.e., rotation axis direction), which allows the recording sheets having a narrow width to be subjected to image recording while being transported in two or more lines in parallel. As a result, the printing efficiency can be improved.

The rolled recording sheet 48 is wound around a cylindrical core member (not shown) so that its image recording surface may be outward in the radial direction. There is no particular limitation to the length and the size in the width direction of the rolled recording sheet 48. For example, a long (namely, web-type) recording sheet whose width is in a range of 89 mm to 210 mm can be used. Moreover, a recording sheet having any arbitrary surface type can be used. For example, a recording sheet having a glossy surface or a matte surface, or a recording sheet on the substrate of which thermoplastic resin is applied can be used.

One flange 40 is attached and fixed to both ends of the core member of the rolled recording sheet 48, and the outer diameter of the flanges 40 is set to be larger than the maximum outer diameter of the roll of recording sheet 48. The flanges 40 have a function of regulating the edges of the rolled recording sheet 48 in the width direction and guiding the recording sheet so that its roll may not collapse in the width direction. The flanges 40 rotate together with the rolled recording sheet 48 as the flange rotation rollers 42 and 44 to be described below rotate.

The flange rotation rollers 42 and 44 are arranged under the flanges 40 to be parallel to each other with a predetermined interval therebetween in the horizontal direction. The flange rotation rollers 42 and 44 support the flanges 40 by abutting the outer peripheries of the flanges 40. The flange rotation rollers 42 and 44 are each connected to a rotary driving unit not shown. The flanges 40 rotate by the forward or backward rotation of the flange rotation rollers 42 and 44, and the rolled recording sheet 48 can be fed (unwound) or wound up, accordingly.

The feed roller pair 46 nips the recording sheet 48 as unwound and transports it to the recording sheet supplying section to be described later.

The recording sheet cassette 36 is a member for containing a pile of recording sheets 50 prepared beforehand as cut sheets with a predetermined size, and is removably attached to the digital photo printer 100. The recording sheets 50 are piled in the recording sheet cassette 36 so that the image recording surfaces thereof may be directed downward. The recording sheets 50 in the recording sheet cassette 36 are picked up one by one by a feed roller 52 located above the recording sheet cassette 36 to be fed to the recording sheet supplying section 14 described later.

In this embodiment, the recording sheets to be loaded in the first rolled recording sheet loading unit 32 and in the second rolled recording sheet loading unit 34 may be of the same type or, alternatively, different types of recording sheets such as recording sheets with different surface types or sizes (i.e., widths).

The recording sheet supplying section 14 is provided so as to transport a long (web-type) recording sheet or cut (cut-sheet type) recording sheet fed from the recording sheet loading section 12 to the image recording section 16. The recording sheet supplying section 14 comprises a cutter 54, a back printing unit 56, a width guide 58, two turn rollers 60 and 62, and three feed roller pairs 64, 66, and 68.

The turn rollers 60 and 62 change the transport direction of the long recording sheets fed nearly horizontally from the first and second rolled recording sheet loading units 32 and 34, respectively, so that the recording sheets may be transported toward the back printing unit 56 located above. The cutter 54 is provided on the way from the turn rollers 60 and 62 to the back printing unit 56. After a predetermined operation has been completed, or when the rolled recording sheet 48 which has not been used up is exchanged with another recording sheet, the cutter 54 cuts the long recording sheet.

The feed roller pairs 64 and 66 can transport the recording sheets 50 fed from the recording sheet cassette 36 toward the back printing unit 56.

The back printing unit 56 is a printing device for recording predetermined back print information on the surface of a long recording sheet or cut recording sheet opposite with the image recording surface, and is provided downstream of the feed roller pair 66 in the transport direction. For example, a dot matrix impact printer or an ink jet printer is used for the back printing unit 56. Examples of the back print information recorded by the back printing unit 56 include an image file name, image correction information, and the like.

The feed roller pair 68 transports the long recording sheet or cut recording sheet which has been subjected to back printing by the back printing unit 56 toward the width guide 58.

The width guide 58 is provided upstream of a feed roller pair of the image recording section 16 which will be described in detail, and can adjust the position of the long recording sheet or cut recording sheet entering the image recording section 16 in the width direction.

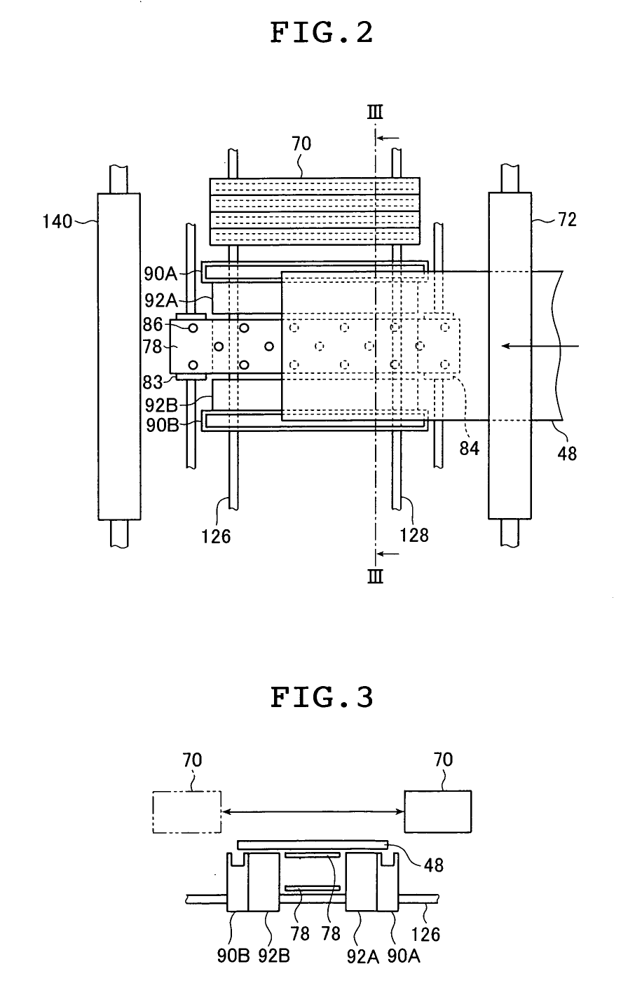

Next, the image recording section 16 will be explained in detail in reference to FIGS. 1 through 3. FIG. 2 is a schematic plan view of the image recording section, and FIG. 3 is a cross-sectional view of the image recording section as shown in FIG. 2, taken along the line III-III.

The image recording section 16 comprises a recording head 70 as an ink ejecting means, a feed roller pair 72, a transport belt 78, a pair of movable ink receivers 90A and 90B, as well as transport guides 92A and 92B. The feed roller pair 72 can transport the recording sheet whose position in the width direction has been regulated by the width guide 58 to the transport belt 78.

The recording head 70 is a serial type ink jet print head that forms an image on a recording sheet while reciprocating in the width direction of the recording sheet (i.e., main scanning direction). The recording head 70 is arranged opposite to the transport belt 78 as shown in FIG. 1, and can form an image in color on the recording sheet transported by the transport belt 78. In the image recording section 16 of the illustrated example, the recording head 70 ejects ink droplets on the recording sheet while moving in the width direction of the recording sheet, and the recording sheet is intermittently moved forward corresponding to the length (i.e., size in the transport direction) of the image formed by the printing head 70 every time the recording head 70 has reciprocated or moved in one direction. Such operations are repeated, and an image can thus be recorded on the recording sheet.

The recording head 70 comprises a plurality of nozzles for ejecting ink. Four nozzle rows corresponding to four colors, cyan (C), magenta (M), yellow (Y) and black (K), respectively, are formed on the recording head 70 on the ink ejection side. The nozzle rows are arranged in parallel in the main scanning direction. As the method of driving the recording head 70, any driving method including a piezoelectric method that utilizes vibration by piezoelectric elements, a thermal method that utilizes pressure of air bubbles generated in the ink by heating elements, and an electrostatic method that utilizes electric charges given to ink droplets can be employed.

As described above, the recording head 70 of this embodiment can form an image on the recording sheet by reciprocating in the main scanning direction. As the method for moving the recording head 70 in the main scanning direction, any method used in known ink jet printers can be employed, which includes a method using a belt and pulley, and a method using a screw transmission.

Upon forming an image on the recording sheet, the recording head 70 can perform borderless printing in which the image is recorded up to the borders (edges) of the recording sheet by ejecting the ink even beyond both side edges of the recording sheet.

The serial print head is used as the recording head 70, however, the recording head 70 is not limited thereto. It is possible to use a line print head in which a plurality of nozzles are arranged along the length nearly equal to the maximum width of the recording sheets to be used.

The transport belt 78 is provided in order to transport the recording sheet 48 fed from the feed roller pair 72 while attracting the recording sheet 48 by suction. The transport belt 78 is an endless belt running between a driving roller 83 and a driven roller 84. The driving roller 83 is connected to a motor not shown, and the transport belt 78 is intermittently revolved by rotating the driving roller 83 by the motor in an intermittent manner. Many regular suction holes 86 are uniformly formed in the transport belt 78, and a fan 75 is arranged below the transport belt 78 as a suction unit used for attracting the recording sheet by suction. The fan 75 can cause the air to flow from the transport belt 78 downward. With the fan 75 being driven, the recording sheet is attracted by suction through the suction holes 86 formed in the transport belt 78. In consequence, the recording sheet in contact with the transport belt 78 under attraction by suction is transported by revolving the belt 78. The number of the fan 75 to be provided as a suction unit may be one or at least two.

In the case of using a line print head as the recording head 70, the transport belt 78 can continuously transport the recording sheet at a constant speed.

The movable ink receivers 90A and 90B are positioned in the vicinity of the edges of the recording sheet 48 and receive the ink ejected beyond the edges of the recording sheet 48 when borderless printing is performed on the recording sheet 48. The movable ink receivers 90A and 90B are each provided with a recess extending in the transport direction of the recording sheet, into which the ink ejected beyond the edges of the recording sheet falls.

Each of the recesses of the movable ink receivers 90A and 90B is slightly longer than the recording head 70. Considering that image forming is to be performed on an area with a size more or less larger than the actual size of the recording sheet used, and that the recording sheet may be displaced in the course of transport, it is preferable that the width (namely, size in the direction orthogonal to the transport direction of the recording sheet) of the recesses be somewhat large so as to allow the recesses to correspond to given regions in which the side edges of the recording sheet are assumed to be centered, respectively.

The movable ink receivers 90A and 90B may be made of metal or a resin. The recesses of the movable ink receivers 90A and 90B may have an ink absorbing member formed therein.

It is also possible to form a port in the bottom of each of the movable ink receivers 90A and 90B in order to remove the ink accumulated in the recesses of the ink receivers 90A and 90B.

The transport guides 92A and 92B are adhered to the inner sides of the movable ink receivers 90A and 90B, respectively. In other words, the transport guide 92A is integrated with the movable ink receiver 90A, and the transport guide 92B with the movable ink receiver 90B. The transport guides 92A and 92B have the top surfaces flatly formed, and are attached to the movable ink receivers 90A and 90B so that their top surfaces may be at the same level as the transport surface of the transport belt 78. The top surfaces of the transport guides 92A and 92B support part of the recording sheet 48 transported by the transport belt 78 at its back so as to keep the recording sheet 48 flat. The transport belt 78 and the transport guides 92A and 92B are so designed that the sum of their widths may be nearly equal to the width of the narrowest of the recording sheets to be used.

Two through holes are formed in each of the movable ink receivers 90A and 90B of the image recording section 16 as shown in FIGS. 2 and 3 through in a direction perpendicular to the transport direction, the holes being located at a predetermined interval in the transport direction. Two similar through holes are formed in each of the transport guides 92A and 92B.

Among the through holes of the movable ink receivers 90A and 90B as well as the transport guides 92A and 92B, those positioned on the upstream side in the transport direction have female threads cut therein, into which a ball shaft 128 is screwed. The through holes positioned on the downstream side in the transport direction are provided with bearings which support a guide shaft 126.

The male thread cut in the part of the ball screw 128 which is to be connected to the movable ink receiver 90A is opposite in orientation to that cut in the part to be connected to the movable ink receiver 90B. When the ball screw 128 is rotated, the ink receivers 90A and 90B, as being guided by the guide shaft 126, move closer to or away from each other in a symmetric manner with respect to the center of the recording sheet.

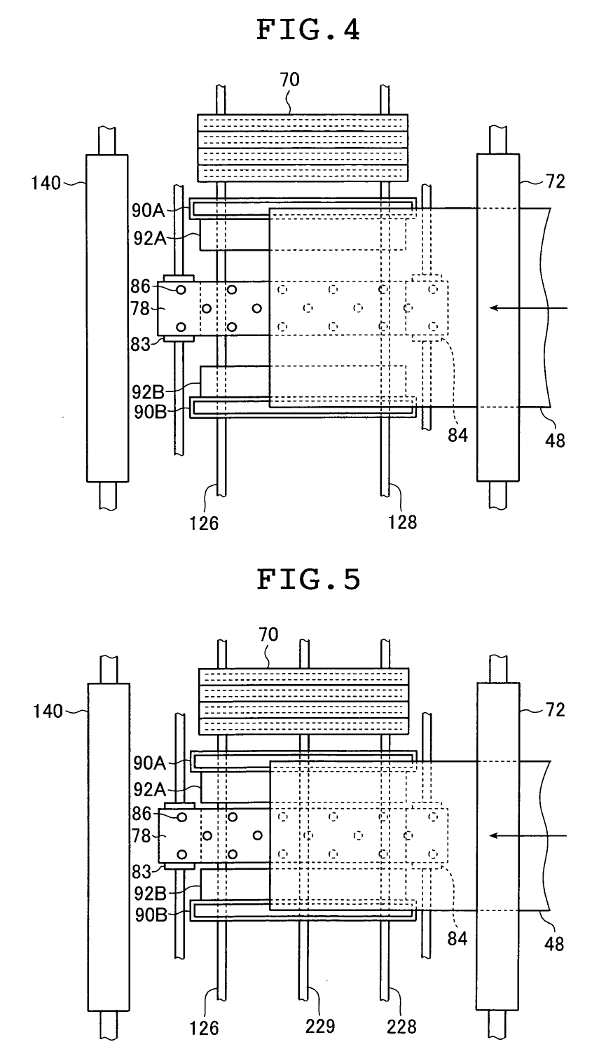

When borderless printing is performed on a recording sheet with a narrow width, the ink receivers 90A and 90B are caused to move closer to each other to position them in the vicinity of the edges of the recording sheet, respectively, as shown in FIGS. 2 and 3. When the recording sheet 48 used to perform borderless printing has a broader width, the ink receivers 90A and 90B are caused to move away from each other to position them in the vicinity of the edges of the recording sheet 48, respectively, as shown in FIG. 4. Thus, in the digital photo printer 100 according to the present invention that is provided in its image recording section 16 with the ink receivers 90A and 90B which are movable, borderless printing can be performed on a recording sheet with any width by promptly position the movable ink receivers 90A and 90B in the vicinity of the two side edges of the recording sheet, respectively.

On condition that the movable ink receivers 90A and 90B as above be provided, a sensor or the like may be used to detect the position of the edges of the recording sheet being transported, and the positioning of the ink receivers 90A and 90B in the vicinity of the sheet edges may be controlled on the basis of detection results. If the positioning of the movable ink receivers 90A and 90B is controlled in accordance with the detection results obtained by a sensor concerning the position of the sheet edges, borderless printing can be performed even on a recording sheet having a width other than predetermined ones, with the ink receivers 90A and 90B being positioned in place in the vicinity of the sheet edges.

The detection results concerning the position of sheet edges may also be used for the position control of the recording head 70 during image recording. In that case, when borderless printing is performed on a recording sheet, displacement of an image formed by the recording head 70 from a proper image formation area can be prevented while making the movable ink receivers on one hand and the sheet edges on the other almost corresponding to each other in terms of position. Consequently, the ink ejected from the recording head 70 toward the outside of the recording sheet can surely be received by the ink receivers 90A and 90B during borderless printing on a recording sheet.

In the example illustrated in FIGS. 2 and 3, the movable ink receivers 90A and 90B are adapted to move closer to or away from each other in a symmetric manner with respect to the center as defined in the width direction of a recording sheet (i.e., center of transportation), although the present invention is not limited to such a configuration. The movable ink receivers 90A and 90B may move independently of each other in a direction perpendicular to the transport direction. FIG. 5 shows an exemplary configuration of the image recording section including a pair of ink receivers which are movable independently of each other. Also in the image recording section as shown in FIG. 5, transport guides are adhered to the inner sides of the movable ink receivers so that they may move together with the ink receivers. In FIG. 5, the same reference characters as in FIGS. 2 and 3 are imparted to the elements which are already shown in the latter figures, and detailed descriptions are no more made on such elements but only on different features.

Movable ink receivers 90A and 90B as well as transport guides 92A and 92B are each provided with three through holes formed in the width direction. In each three through holes, a first ball screw 228 for moving the movable ink receiver 90A (also referred to as first movable ink receiver), a second ball screw 229 for moving the movable ink receiver 90B (also referred to as second movable ink receiver), and a guide shaft 126 for guiding both of the movable ink receivers 90A and 90B are inserted, respectively.

The first movable ink receiver 90A has a female thread cut in the through hole in which the first ball screw 228 is inserted, and the second movable ink receiver 90B has the one cut in the through hole in which the second ball screw 229 is inserted.

A bearing is provided in each of the through hole of the first movable ink receiver 90A in which the second ball screw 229 is inserted and the through hole of the second movable ink receiver 90B in which the first ball screw 228 is inserted. A bearing is also provided in each of the through hole of the first movable ink receiver 90A and the through hole of the second movable ink receiver 90B in which holes the guide shaft 126 is inserted.

The first ball screw 228 has a male thread cut only in its part which is connected to the first movable ink receiver 90A, and not in the part which is connected to the second movable ink receiver 90B. On the other hand, the second ball screw 229 has a male thread cut not in its part which is connected to the first movable ink receiver 90A but the part which is connected to the second movable ink receiver 90B. By imparting such configurations to the first and second ball screws 228 and 229 and rotating the screws 228 and 229 independently of each other using motors (not shown) independently provided, the first and second movable ink receivers 90A and 90B can be moved independently of each other in a direction perpendicular to the transport direction.

The movable ink receivers 90A and 90B of the above structure, as being capable of moving independently of each other in a direction perpendicular to the transport direction of a recording sheet, are positioned in the vicinity of the sheet edges even if the recording sheet is displaced in the width direction during transportation.

When the first and second movable ink receivers 90A and 90B are adapted to move independently of each other as described above, the transport belt 78 is preferably also movable in a direction perpendicular to the transport direction. In that case, it is preferable that the transport belt 78 be moved so that it may always be aligned with the recording sheet used. With the transport belt 78 being positioned corresponding to the center of the recording sheet used, the recording sheet can be transported by the belt 78 stably even if it has a width different from that of the preceding sheet.

Such movable ink receivers and movable transport belt as described above are useful when a line print head is used as the recording head. For example, in the case where a line print head is used as the recording head and an image is recorded while transporting the recording sheet in such away that a center of the printing medium in the width direction is positioned as a reference (with its center being positioned according to the reference), the ink ejection units of the line print head which are corresponding to the recording sheet having a narrow width are always driven regardless of the width of the recording sheet used. In contrast, the ink ejection units which are located outside the ink ejection units corresponding to the recording sheet with a narrow width and are only corresponding to the recording sheet with a broad width are driven less frequently. Therefore, the ink is ejected more frequently from the ink ejection units that are located in the center of the line print head and are always driven regardless of the width of the recording sheet used than from those which are located at the end portions of the line print head and are driven only when the recording sheet having a broad width is used. Thus, the ink ejection units in the center of the line print head are more liable to deteriorate. On the other hand, the ink ejection units which are driven only when the recording sheet having a broad width is used and, consequently, from which the ink is ejected less frequently tend to an ejection failure due to the clogging with ink, for instance. Accordingly, if the position of the recording sheet transported to the image recording section is changed in the width direction intentionally so as to change the region as appropriate to which the ink is to be ejected from the line print head, the ink ejection units can be made uniform in ink ejection frequency. Even when the transport position of the recording sheet fed into the image recording section has been changed in the width direction, a movable transport belt can follow the recording sheet and transport it in a position opposite to the line print head. In addition, movable ink receivers can adequately be positioned in the vicinity of the edges of a recording sheet even if the transport position of the recording sheet is changed. Thus, movable ink receivers and transport belt are useful in the case where the transport position of a recording sheet is changed in the width direction in order to make the ink ejection units of a line print head uniform in ejection frequency.

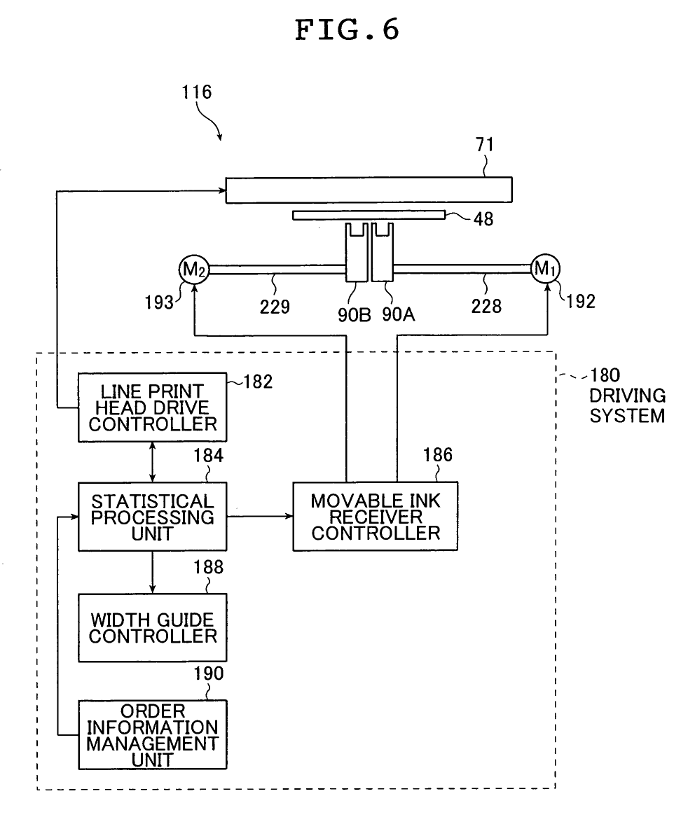

The following description is made with reference to FIG. 6 on an embodiment of the present invention adapted to level out the driving frequency for the ejection units of a line print head, and to subject a line print head to flushing by using movable ink receivers. FIG. 6 contains a schematic cross-sectional view of an image recording section 116 including a line print head 71, and a block diagram illustrating part of a driving system 180 of the image recording section 116. The driving system 180 includes a print head controller 182 for controlling the driving of the line print head 71, a statistical processing unit 184, an ink receiver controller 186 for controlling movable ink receivers, a width guide controller 188, and an order information management unit 190.

Similar to the movable ink receivers as shown in FIG. 5, a pair of movable ink receivers (namely, first and second movable ink receivers) 90A and 90B of this embodiment can be moved in the width direction of a recording sheet independently of each other. As shown in FIG. 6, a first ball screw 228 for driving the first movable ink receiver 90A and a second ball screw 229 for driving the second movable ink receiver 90B are connected to motors 192 and 193, respectively. The motors 192 and 193 are each connected to the ink receiver controller 186 to be described later, which regulates the position of the first and second movable ink receivers 90A and 90B by controlling the motors 192 and 193, respectively.

The image recording section 116 shown in FIG. 6 may include transport guides and a transport belt, as is the case with the image recording section as described above.

The line print head 71 is connected to the print head controller 182 which controls the ejection of ink by the print head 71.

The print head controller 182 outputs driving signals to the individual ejection units of the line print head 71 on the basis of image data. The print head controller 182, as being also connected with the statistical processing unit 184, outputs the above driving signals simultaneously to the statistical processing unit 184. The statistical processing unit 184 calculates the driving frequency for the individual ejection units of the line print head 71 based on the driving signals outputted by the print head controller 182 so as to manage the information concerning the driving frequency for the individual ejection units. In addition, the statistical processing unit 184 can identify the ejection units which have been driven with a frequency above the average and those which have been driven with a frequency below the average, based on the information concerning the driving frequency for the individual ejection units of the line print head 71. The driving frequency for an ejection unit may be calculated on the basis of the number of times the ejection unit has ejected ink, the period of time over which the ejection unit has been driven, or the like. The statistical processing unit 184 may manage the information concerning the driving frequency for all the ejection units of the line print head 71 by calculating the driving frequency for all units, or manage the information concerning the driving frequency for the ejection units selected at certain intervals in the direction of the length (size in the width direction) of the line print head 71 by calculating the driving frequency for such units.

Based on the driving frequency calculation results, the statistical processing unit 184 sets the position in the width direction of the recording sheet to be subsequently transported so that the driving frequency may be leveled out for all the ejection units by driving the ejection units which have been driven with a low frequency. Then, the statistical processing unit 184 outputs to the width guide controller 188 the directive information that allows the position of the recording sheet to be changed by the width guide 58 in the width direction so that the recording sheet may be transported in the set position, and simultaneously outputs to the ink receiver controller 186 the directive information for instructing the controller 186 to change the position of the movable ink receivers 90A and 90B. In accordance with the directive information from the unit 184, the width guide 58 regulates the transport position of the recording sheet, and the ink receiver controller 186 changes the movable ink receivers 90A and 90B in terms of position by controlling the motors 192 and 193, respectively.

The regulation of the transport position of a recording sheet in order to level out the driving frequency as above may be performed for each print order, or on the basis of the print head driving time or the number of recording sheets.

The statistical processing unit 184 is also connected to the order information management unit 190, from which the unit 184 receives order data on standby. The order information management unit 190 manages order data (namely, pieces of information involved in orders) entered by individual customers upon the order for photographic prints. The order data include the number and size of the prints to be made in accordance with an order. When the statistical processing unit 184 identifies the ejection units which have been driven at a frequency above the average driving frequency found with respect to the whole of the line print head 71 and those which have been driven at a frequency below the average driving frequency, the order data are also taken into account.

It is another function of the statistical processing unit 184 to determine the time of flushing based on the driving frequency for the ejection units of a line print head. Details are as follows.

The statistical processing unit 184 identifies those ejection units of the line print head 71 which have not ejected ink over a specified period of time at the end of which, for instance, ink may dry to cause clogging of ejection units, or even longer. The period of time can preferably be set in a separate manner depending on whether the ink to be used is of the pigment, dye, or some other type.

Then, the statistical processing unit 184 determines the time at which the ejection units not having ejected ink for a specified period of time are to be driven from the width and transport position of the recording sheets to be fed subsequently to the recording sheet on which printing is being performed. It is assumed, for instance, that the printing job be performed on the twelfth recording sheet of A3 size following eleven recording sheets of A4 size. The statistical processing unit 184 sets the time of flushing to the time when the next order to be carried out is selected prior to the printing on the twelfth recording sheet of A3 size because those ejection units of the line print head 71 which have not ejected ink for a specified period of time need to be subjected to flushing before ejecting ink for the recording on a recording sheet.

To be more specific: At the time when the next order is selected, the statistical processing unit 184 outputs to the ink receiver controller 186 the directive information that allows the movable ink receivers 90A and 90B to be positioned in the vicinity of the lateral ends of the line print head 71. The ink receiver controller 186 moves the movable ink receivers 90A and 90B by controlling the motors 192 and 193, respectively, in accordance with the directive information so as to position the ink receivers 90A and 90B in the vicinity of the lateral ends of the line print head 71, respectively. The line print head 71 is then caused to flush the ejection units sequentially from its lateral ends toward the inside in the width direction. During the flushing, the movable ink receivers 90A and 90B are moved toward the inside appropriately with the progress of flushing so that the ink for flushing may be received by them. Since the flushing as above is performed before an image is recorded on the recording sheet of A3 size, ink can be ejected upon image recording favorably even from the ejection units on the lateral-end portions of the line print head 71 which have not ejected ink for a specified period of time, leading to a successful formation of an image on the recording sheet of A3 size.

In the embodiments as described above, recording sheets having different widths are transported with the center of each sheet being positioned according to the reference. If recording sheets having different widths are transported to the image recording section with one or the other side edge of each sheet being positioned according to the reference, the ink receiver to be located in the vicinity of the side edge positioned according to the reference may be a stationary one and that to be located in the vicinity of the other side edge be movable. In that case, the transport belt is preferably adapted to be movable in the width direction of a recording sheet. When a recording sheet different from the preceding one in width is transported, such a transport belt can be positioned corresponding to the center of the recording sheet transported to the image recording section and, accordingly, can transport the recording sheet stably by supporting its center.

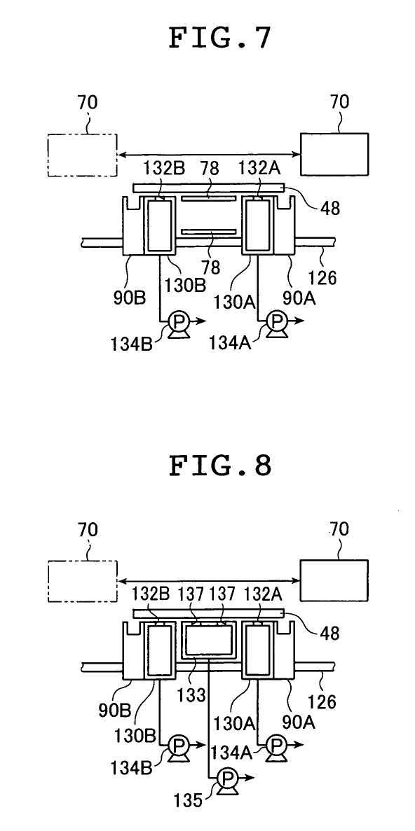

The transport guides 92A and 92B of the image recording section as shown in FIGS. 2 and 3 may be adapted to attract by suction the recording sheet being transported. FIG. 7 shows an exemplary configuration of the image recording section including transport guides which attract a recording sheet by suction. The image recording section as shown in FIG. 7 includes transport guides 130A and 130B each having a hollow body, and the tops of the transport guides 130A and 130B which come into contact with a recording sheet have a plurality of suction holes 132A and 132B formed therein, respectively, which holes, as being bored through the tops, open to the interior of the hollow bodies. In each of the transport guides 130A and 130B, the relevant suction holes 132A or 132B are aligned in the transport direction at certain intervals. The transport guides 130A and 130B are connected to pumps 134A and 134B, respectively, so that it is possible to exhaust the air inside the transport guides 130A and 130B with the pumps 134A and 134B so as to attract a recording sheet 48 by suction through the suction holes 132A and 132B and thereby bring it into a moderate contact with the top surfaces of the transport guides 130A and 130B.

If the recording sheet 48 being transported is attracted by suction through the suction holes 132A and 132B of the transport guides 130A and 130B, the drooping or curling of its edges will be prevented and the recording sheet 48 will be kept flat, accordingly.

While recording sheets are transported using a transport belt in the embodiments as described above, a long recording sheet in a rolled form can be transported during image recording thereon by, for instance, a transport roller pair 140 as shown in FIG. 1 even if a transport belt is omitted. Consequently, if long, rolled recording sheets are exclusively used, such a configuration may be employed in which no transport belts are provided, but a tensile force is exerted on the recording sheet by causing the transport roller pair 140 downstream of the image recording section to act on the recording sheet with a touch of tension, that is to say, by making the transport speed of the transport roller pair 140 slightly higher than that of the feed or transport roller pair 72 on the upstream side, and the recording sheet as such is rested on a printing stage capable of keeping the recording sheet flat only in its portions for recording, or a printing stage having a function of attracting the recording sheet by suction.

FIG. 8 is a schematic cross-sectional view of the image recording section as a modification of the image recording section shown in FIG. 7 which includes a printing stage having a flat top surface. In FIG. 8, the same reference characters as in FIG. 7 are imparted to the elements which are already shown in the latter figure, and detailed descriptions are no more made on such elements.

Similar to the transport guides 130A and 130B as shown in FIG. 7, a pair of transport guides 130A and 130B as shown in FIG. 8 each have a hollow body, and they are attached to the inner sides of a pair of ink receivers 90A and 90B, respectively. As seen from FIG. 8, a printing stage 133 sandwiched between the transport guides 130A and 130B also has a hollow body. The transport guides 130A and 130B as well as printing stage 133 are arranged so that their top surfaces may be at the same level. The tops of the transport guides 130A and 130B as well as printing stage 133 have a plurality of regular suction holes 132A, 132B and 137 uniformly formed therein, respectively, which holes, as being bored through the tops, open to the interior of the hollow bodies.

The transport guides 130A and 130B as well as printing stage 133 are connected to pumps 134A, 134B and 135, respectively, so that it is possible to exhaust the air inside the transport guides 130A and 130B as well as printing stage 133 by actuating the pumps 134A, 134B and 135 so as to attract a recording sheet by suction through the suction holes 132A and 132B of the transport guides 130A and 130B as well as the suction holes 137 of the printing stage 133, and thereby bring the recording sheet into a moderate contact with the transport guides 130A and 130B as well as printing stage 133. If the recording sheet transported during recording is attracted by suction as described above, the lifting or curling of the recording sheet will be so prevented that the recording sheet can be kept flat and, consequently, the distance between the recording head and the recording sheet kept constant, leading to an image formation with no distortion but a high definition.

The strength of suction at the transport guides 130A and 130B may or may not be the same as that at the printing stage 133. The strength of suction may be made different between the transport guides 130A and 130B and the printing stage 133 by, for instance, causing the suction holes 132A and 132B of the transport guides 130A and 130B on one hand and the suction holes 137 of the printing stage 133 on the other to differ from each other in size or number.

A recording sheet may no more be transported if too strong a suction is exerted on it through the suction holes 132A, 132B and 137 formed in the transport guides 130A and 130B as well as printing stage 133. It is therefore desirable to adjust the number of revolutions of a fan as well as the size and number of the suction holes 132A, 132B and 137 so that suction may be exerted of such a strength as permits the transportation of a recording sheet 48.

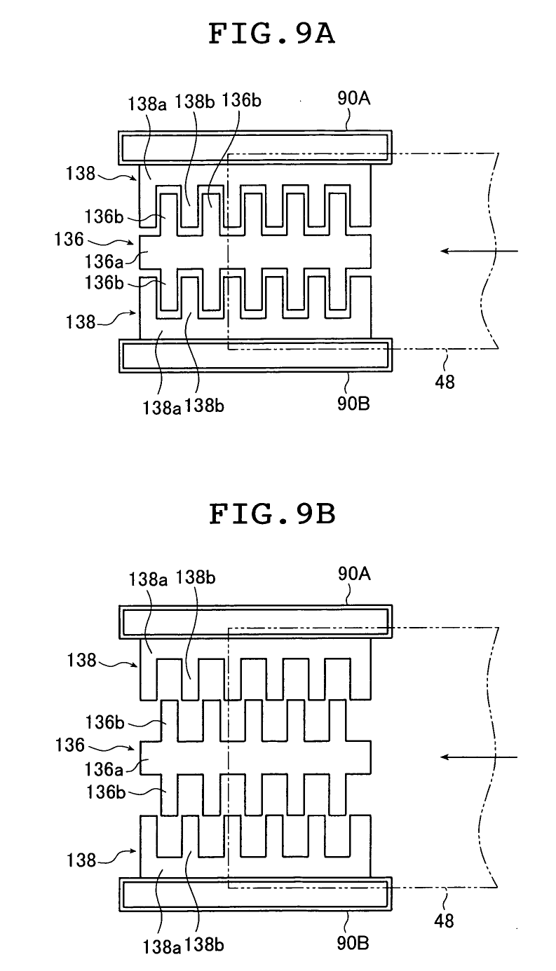

The transport guides 130A and 130B as well as printing stage 133 as shown in FIG. 8 each having a hollow, rectangular-solid body may also be flat and plate-like in shape. Flat, plate-shaped printing stage and transport guides are preferably adapted to support the largest possible part of a recording sheet at its back when movable ink receivers are moved corresponding to the width of the recording sheet. In order to realize such a function, shapes as shown in FIGS. 9A and 9B may be imparted to the printing stage and transport guides. FIGS. 9A and 9B are schematic plan views of a printing stage in plate form, transport guides in plate form, and movable ink receivers. In FIGS. 9A and 9B, a printing stage 136 has an elongated plate-like member (main part) 136a extending in the transport direction, and a plurality of rectangular extensions 136b which are arranged on both lateral sides of the member 136a at specified intervals and extend outwardly in the direction orthogonal to the transport direction. Transport guides 138 each have an elongated plate-like member (main part) 138a extending in the transport direction, and a plurality of rectangular extensions 138b which are arranged on the inner lateral side of the member 138a at specified intervals and extend inwardly in the direction orthogonal to the transport direction. In the example illustrated, the extensions 136b and 138b of the printing stage 136 and the transport guides 138 are designed so that their intervals and sizes may allow some gap between the extensions 136b of the printing stage 136 on one hand and the extensions 138b of the transport guides 138 on the other when each extension 138b is positioned between two adjacent extensions 136b and vice versa.

When borderless printing is to be performed on a recording sheet with the narrowest width, the printing stage 136 and the transport guides 138 are positioned so that the extensions 136b and the extensions 138b may be staggered with respect to each other as shown in FIG. 9A. When borderless printing is to be performed on a recording sheet with a broader width, movable ink receivers 90A and 90B are moved corresponding to the width of the recording sheet as shown in FIG. 9B. In that case, the recording sheet is supported at its back not only by the main parts 136a and 138a of the printing stage 136 and the transport guides 138 but their extensions 136b and 138b, so that it is possible to keep the recording sheet flat even if it has a relatively small thickness and, as a result, is liable to be sagged by gravity.

It should be noted that a rectangular extension may have a rounded tip.

Next, the drying section 18 of the digital photo printer 100 will be explained referring to FIG. 1. The drying section 18 is provided in order to facilitate the drying of the ink on the recording sheet which has an image recorded thereon by the image recording section 16. The state of drying of the ink is different depending upon the type of the recording sheet or the ink to be used. Thus, for example, in the case of using the recording sheet having such a property that the ink placed thereon dries immediately or using the ink which dries immediately, the drying section 18 need not be provided. In the example as shown in FIG. 1, the drying section 18 comprises the transport or feed roller pair 140, and a drying fan 142. The drying fan 142 blows air to the image forming surface of the recording sheet being transported, thereby facilitating the drying of the ink. The feed roller pair 140 is provided to transport the recording sheet which has passed through the place in which the drying fan 142 is provided.

In the illustrated example, drying of the ink is facilitated by the drying fan, however, a heater may be used instead of the drying fan so as to facilitate the drying of the ink. In order to further facilitate the drying of the ink, the drying fan and the heater may be used in combination.

A loop forming unit 144 is provided downstream of the drying section 18 in the transport direction. When a long recording sheet is used, a loop is formed at the loop forming unit 144. The loop forming unit 144 comprises two feed roller pairs 146 and 148, and smoothes out the output speed differences generated among the image recording section 16, the drying section 18, and the later described surface treatment section 20. By releasing a not shown transport guide, a loop of the recording sheet is formed, and the load that affects the surface treatment section requiring a continuous transport of the recording sheet can thus be avoided.

In the case of using a recording sheet in which thermoplastic resin is used for the image forming surface, the surface treatment section 20 can perform the surface treatment on the image forming surface. The surface treatment section 20 comprises a heat/pressure roller pair 150, a transport belt 152, a cooling unit 154, and a separation roller 156. The transport belt 152 is an endless belt which runs between the lower roller of the heat/pressure roller pair 150 and the separation roller 156.

The heat/pressure roller pair 150 can melt the thermoplastic resin of the image recording surface by heating and pressing the recording sheet. The transport belt 152 is for transferring the surface characteristics thereof onto the thermoplastic resin of the image recording surface of the recording sheet that has been melted by the heat/pressure roller pair 150. Therefore, by making the surface of the transport belt 152 glossy, the image recording surface of the recording sheet can be made glossy.

The cooling unit 154 can solidify the melted thermoplastic resin by cooling it and thereby fix the surface characteristics transferred from the transport belt 152 to the recording sheet. The cooling unit 154 is arranged below the transport belt 152 between the heat/pressure roller pair 150 and the separation roller 156 in the transport direction of the recording sheet.

The separation roller 156 is a roller around which the transport belt 152 is revolved. The diameter of the separation roller 156 is made extremely small, whereby the recording sheet whose thermoplastic resin has been cooled and solidified can be separated from the transport belt 152.

The cutting section 22 is provided for cutting the rolled recording sheet into prints having a predetermined length, and comprises feed roller pairs 160, 162, and 164, a loop forming unit 166, and a cutter 168.

The feed roller pair 160 is provided downstream of the surface treatment section 20, and transports the recording sheet having passed through the surface treatment section 20. The linear speed of the feed roller pair 160 is controlled to accord with the transport speed of the recording sheet at the surface treatment section 20. The feed roller pair 162 is arranged downstream of the feed roller pair 160 in the transport direction by a predetermined interval, and transports the recording sheet to the cutter 168. During cutting of the recording sheet with the cutter 168, the transportation of the recording sheet needs to be stopped, so that the feed roller pair 162 is controlled to transport the recording sheet intermittently.

The loop forming unit 166 is provided between the feed roller pairs 160 and 162, and can smooth out the output speed difference between the surface treatment section 20 and the cutting section 22. By releasing a transport guide (not shown) arranged in a direction perpendicular to the transport surface, a loop of the recording sheet is formed at the loop forming unit 166. In consequence, the load that affects the surface treatment section 20 requiring a continuous transport of the recording sheet is avoided, which results in a stable surface treatment at the surface treatment section 20.

The discharge section 24 comprises a feed roller pair 170 and an orthogonal transport belt 172. The feed roller pair 170 is provided downstream of the feed roller pair 164 of the cutting section 22, and discharges the prints transported from the feed roller pair 164 through a discharging port (not shown) of the case of the digital photo printer. The orthogonal transport belt 172 can transport the prints discharged from the discharging port in the direction perpendicular to the plane of FIG. 1 (i.e., toward the person looking at the figure).

The prints transported by the orthogonal transport belt 172 are collected on a collection tray (not shown). The collection tray may be a revolving sorter for sorting the prints in units of orders.

While the image recording apparatus of the present invention has been explained in detail, the present invention is in no way limited to the abode described embodiments and it should be understood that various improvements and modifications are possible without departing from the gist of the present invention.

What is claimed is:

1. An image recording apparatus for forming an image on each printing medium of two or more types of printing media having different widths, comprising:
an ink ejection device for ejecting ink droplets toward a surface of a printing medium in said two or more types of printing media; and
a pair of ink receivers which are positioned near to both side edges of said printing medium in a width direction perpendicular to a transport direction of said printing medium, and receive said ink droplets ejected from said ink ejection device and landed beyond said both side edges of said printing medium in said width direction,
wherein at least one ink receiver of said pair of ink receivers is moved in said width direction in accordance with each of widths of said two or more types of printing media having the different widths.

2. The image recording apparatus according to claim 1, wherein each printing medium of said two or more types of printing media having the different widths is transported in such a way that a center of each printing medium in said width direction is positioned as a reference, and said pair of ink receivers are moved to or away from each other in a symmetric manner with respect to said center in said width direction.

3. The image recording apparatus according to claim 1, wherein each printing medium of said two or more types of printing media having the different widths is transported in such a way that one side edge of each printing medium is positioned as a reference, and one ink receiver of said pair of ink receivers which is to be positioned near to another side edge of each printing medium opposite to said one side edge of each printing medium is moved in said width direction perpendicular to the transport direction of said printing medium.

4. The image recording apparatus according to claim 1, wherein said pair of ink receivers are moved in said width direction perpendicular to said transport direction independently of each other.

5. The image recording apparatus according to claim 1, further comprising a transport guide which is moved together with the ink receiver to support said printing medium at its back and is provided on each inner side of said pair of ink receivers in said width direction perpendicular to said transport direction.

6. The image recording apparatus according to claim 1, wherein said ink ejection device is reciprocated in a direction which is parallel to said surface of said printing medium and perpendicular to said transport direction of said printing medium so as to form said image on said printing medium.
